(19) United States
(12) Patent Application Publication
(10) Pub. No.: US 2025/0098711 A1
(43) Pub. Date: Mar. 27, 2025

(54) EXCIPIENT POWDER DELIVERY SYSTEM

(71) Applicant: TabBrands Inc., Laguna Beach, CA (US)

(72) Inventors: Michael Gulyas, Laguna Beach, CA (US); Dean Harris, Norwalk, CT (US)

(21) Appl. No.: 18/373,013

(22) Filed: Sep. 26, 2023

(51) Int. Cl. A23L 2/38; A23L 2/39; A23L 2/52; A23L 33/105

(52) U.S. Cl. CPC A23L 2/38; A23L 2/39; A23L 2/52; A23L 33/105

(57) ABSTRACT

An excipient powder product containing cannabinoids, terpenes and cannabidiol (CBD) and a process for producing an excipient supplement powder. The excipient powder having a density that enables the excipient powder to dissolve when it is added to or submerged in any liquid, including non-carbonated and carbonated liquids, with or without stirring. The floating delivery system yields an excipient powder bulk density that is lower than the gastric fluid and allows the active components to remain buoyant for extended time periods without affecting the rate of gastric emptying.

### TECHNICAL FIELD

The present disclosure relates generally to a delivery system, and more particularly to an excipient product containing active ingredients of hemp, cannabis extract, or Cannabidiol.

### BACKGROUND

There is a growing need for faster and more efficient mechanisms to distribute vitamins, supplements, and pharmaceutical substances to the average person in their daily life.

One example of an industry where distribution and transport are particularly troublesome is in the supplement industry, which serves a vast number of people from body-builders to vegans/vegetarians. Similar problems are faced within markets associated with trade in pharmaceuticals and additives. People consume a wide variety of supplements and additives for a variety of reasons, and these industries have continued to grow in diversity in terms of the supplements and additives offered as well as the types of consumers being targeted. One of the challenges faced by these industries is how to package and distribute supplements, pharmaceuticals and additives so that they can be easily carried and consumed at a convenient time by the consumer.

There is a pervasive trend in the supplement industry, and particularly in the protein powder industry, to sell the supplement in a loose powder form packaged inside of a tub with a scooper. The scooper is generally kept inside the tub and, in order to consume the powder a consumer will generally open the tub, scoop out the desired amount of supplement powder into a container, and then mix the supplement powder with water until it forms a suspension and can be consumed. This process is not only time-consuming, but requires that the user know the appropriate amount of protein that needs to be consumed. The biggest problem with the current packaging and distribution process is that the tubs commonly used to store and sell the supplement powder are not convenient for carrying around, e.g., to take to the gym or carry with you to work, etc. Moreover, such delivery mechanisms do not allow for easy insertion into the necks of plastic water bottles and other beverages.

In addition, it is unhygienic for a consumer to reach a scooper into the tub with uncovered hands, especially if the consumer is sweaty after a workout. There is also a lack of precision and control over the quantity of protein included in each shake due to the fact that the scooper is of a uniform size and there is no convenient or accurate way to measure out a fraction of a scoop. If multiple supplements are to be included in a shake, the process of opening the tub, measuring the powder, pouring it into the container, replacing the scooper, and closing the tub must be performed for each supplement.

Additionally, a need exists for the efficient delivery of additives such as cannabidiol, cannabis derivatives. Existing delivery mechanisms, including edible food-based delivery systems and smoking mechanisms remain inefficient and associated with undesirable side effects. Such delivery mechanisms also are accompanied by undesirable pollutants. Cannabidiol, cannabis derivatives, and cannaboids often are mis-measured and mis-dosed. These undesirable aspects of existing cannabinoid delivery mechanisms remain particularly problematic in association with the delivery of cannaboids in association with medical usage. This is particularly the case with regard to THC-A, which has been found to have substantial benefit to the peripheral nervous system (for pain management), the gut and the immune system. A need exists for an improved delivery system that better delivers the more easily extracted THC-A, which is water-soluble and does not require heat to extract, and therefore more easily retains other beneficial compounds such as terpenes and CBD. Aspects of the present invention are directed to these and other problems.

### DETAILED DESCRIPTION

The present disclosure describes an excipient powder formulation comprises a cannabidiol, cannabis product. In an embodiment of the invention, the cannabidiol, cannabis product comprises THC. In an embodiment of the invention, the cannabidiol, cannabis product comprises THC-A.

The excipient powder coating contains protein, and may also contain protein, vitamins, medicines, THC, THC-A, caffeine, and other agents or supplements that may be found in the supplement powder. In an embodiment, the coating serves as a moisture barrier. The present inventors recognize that to maintain optimal excipient qualities, the excipient powder packaging system should maintain optimized moisture levels in accordance with the teachings contained within U.S. Pat. No. 6,495,163 with a filing date of Sep. 23, 1998, which is hereby incorporated by reference in its entirety. The coating may be an excipient coating to aid in the mixing of components with the liquid, or the powder itself may be an excipient powder due the incorporation of excipient substances within its composition. In such embodiments, the excipient activity may be accomplished through the incorporation of sodium bicarbonate, and/or potassium bicarbonate in the composition of supplement powder and/or in the coating. In an alternative embodiment, the excipient activity may be accomplished through use of arginine in the supplement powder and/or in the coating of excipient components. The present inventors have recognized the benefit of using arginine as a non-sodium alternative to provide excipient activity, as many seek to avoid the addition of sodium to their diets. These ingredients react with water to create an acid base reaction releasing CO₂ and aiding the excipient activity.

As used herein, excipient means that the substance (in either the coating and/or excipient powder) reacts with a liquid causing the release of gas. Moreover, in an embodiment, the excipient powder may incorporate one or more disintegrants. Disintegrants in the context of the invention are described as substances that aid in the dispersion of the powder into a fluid. More precisely, disintegrants are described as substances intended to aid in the dispersion of the excipient powder when it is put into a fluid environment. Disintegrants promote moisture penetration and dispersion of the excipient components. In embodiments of the invention, particularly embodiments that incorporate protein in the supplement powder, the formulation incorporates Chitosan as a disintegrant. The present inventors have recognized that Chitosan assists with the dispersion of the excipient powder comprising protein once it reaches a wet substance.

In alternative embodiments, the excipient powder may incorporate any of the following as a disintegrant: crosscarmellose sodium, Ac-Di-Sol, primellose, vivasol, crosdpovidone, kollidon, polyplasdone, sodium starch glycolate, alginic acid, satialgine, soy, polysaccharides, emcosoy, and/or calcium silicate. In an embodiment, the inclusion of one or more disintegrants causes rapid dispersion of the excipient components once placed in a liquid. In an embodiment of the invention, the dispersion of the powder within the fluid would take approximately 15-20 seconds to fully distribute within the fluid if the supplement powder contains protein. In an embodiment where the supplement powder contains a cannabidiol, or a cannabis derivative, the time to dispersion would take approximately 10-15 seconds. While excipient activity typically refers to the release of carbon dioxide, it can refer to other gases escaping as well. In embodiments of the invention, the supplement powder is configured to comprise a dosage of THC in an amount between 1 milligram and 10 milligrams. In embodiments of the invention, the supplement powder is configured to comprise an amount between 0.5 milligrams of CBD and 8 milligrams of CBD. In an embodiment of the invention, the supplement powder is configured to contain precisely 5 milligrams of THC and 2 milligrams of CBD. The present inventors have recognized that THC-A provides many of the desired physiological effects of THC, however, due to being acidic and water-soluble, THC-A does not cross the blood brain barrier and therefore does not create undesirable psychological effects. In varying embodiments of the invention, therefore, within the supplement powder, THC-A is used in place of THC.

In other embodiments, the shake formed by mixing the excipient powder with the liquid is a suspension where the supplement powder is suspended in water. In yet other embodiments, the supplement powder forms a solution when mixed with water. The excipient powder is designed to disperse in water relatively quickly, within a time range of 1 second to 60 seconds.

A system 100 provides for customizing the packaged product. The system 100 includes a consumer 102, which operates a consumer computing device 104 to input supplement selections 106 and consumer preferences 108. The supplement selections 106 and consumer preferences 108 are sent to a distributor computer 112 through a network 110. The distributor computer 112 has a supplement selection program 114 executing thereon for generating a supplement order 116 using the information provided in the supplement selections 106 and the consumer preferences 108. The distributor computer 112 may store information such as the supplement selections 106, consumer preferences, or supplement order 116 on a consumer information database 118 for later usage.

An excipient powder packaging system 120 receives the supplement order 116 and uses it to form supplement packages 122 having the right supplements, e.g., supplement type, quantity, flavor, etc. The supplement packages 122 are compressed by the packing system 120 to an appropriate density so that it will disperse in liquid. The excipient powder components are received by the supplement packager 124 which packages the excipient powder 122 to form packaged supplements 126, which are then sent to the consumer 102.

In some embodiments, the supplement selections 106 may include information such as protein type, protein flavor, cannabidiol, cannabis type, cannabidiol, cannabis flavor, protein quantity, cannabidiol, cannabis quantity, THC quantity, THC-A quantity, vitamins, minerals, and nutrients that a consumer 102 wishes to be included in the packaged supplements 126 that are sent to them. In other embodiments, the consumer preferences 108 include information about the consumer's age, weight, sex, build, training goals, medical needs, and dietary restrictions, and the supplement selection program 114 determines the supplement selections 106 for a consumer 102 based on the consumer preferences 108 entered by the consumer 102. This embodiment allows the consumer 102 to receive a product tailored to their needs even if they do not have the expertise to make the selections on their own. In other embodiments, the consumer 102 can include their prescribed pharmaceutical drugs, allergy medication, daily vitamins, medical or recreational marijuana, and other substances with their supplement selections 106 so that they are given an all-inclusive formulation that meets their dietary needs. An advantage of this embodiment is that certain substances may be absorbed by the body faster when consumed in the form of a liquid solution or suspension.

The packaged product 10 offers several advantages over known products. Among other things, the packaged product 10 is designed for a single use, allowing a consumer to easily transport and consume their protein powder in the form of an excipient powder so that when the consumer wishes to make a protein shake, all they have to do is introduce the excipient powder from the package 20 and shake it up with water to create the shake. This allows, for instance, gym-goers to avoid having to use a scooper with a tub of protein which is bulky and inconvenient to carry around, and also requires measuring, which can be inconvenient and unhygienic. The package 20 also provides an advantage by being sized to fit in a clothing pocket or a purse, e.g., the pocket of athletic wear such as a small thigh pocket on running spandex designed for a key (i.e., a “key pocket”) or small zipper pocket in a fleece for storing a credit card (e.g., a “card pocket”). In other examples, the package 20 offers the advantage of being sized for concealment.

The packaged product system 100 also allows for increased efficiency since a consumer may customize their excipient powder product so that each package has precisely the right supplements for the dietary needs. For example, an athlete taking multiple supplements seeking to control their supplement intake with precision and ease can benefit greatly from the packaged product system 100 since it replaces a series of complicated and time-consuming measurements of various powders and pills from multiple containers each time the athlete wishes to consume a supplement shake. Such consumption might also take place by anyone, athlete or otherwise, who wishes to improve their overall wellness. An athlete just starting out with a supplement regiment can also benefit from the packaged product system since it can aid a consume in selecting the supplements they wish to take, or even calculate certain things for them, (e.g., determining quantity based on their training goals/weight/sex, or determining protein type (plant or casein) based on dietary restrictions or allergies.

The packaged product 10 also provides an advantage since it may be used to deliver other ingestible items or combined with a user's other vitamins/medicine to meet the user's supplement/medical needs with one item. Advantages also include that large doses of ingredients can be taken in a single serving, and nutrients can be absorbed by the body faster than if taken in other forms such as pills.

With conventional solid tablets or capsules that are swallowed by a user, the tablet is transported to the user's stomach after being swallowed, where it dissolves gradually. The passage time varies in different people, depending on anatomical and physiological factors. In case of a longer passage time, solid dosage forms can dissolve partially and this may cause irritation of mucous membranes. Advantages of the packaged product 10 include that because it is dissolved in liquid the ingredients are evenly distributed in the solution, and high, localized concentrations cannot occur.

The present invention is a bulk powder, excipient powder, or single use packet or sachet containing an excipient supplement powder with a density that enables the excipient powder to dissolve when it is added to or submerged in any liquid, including non-carbonated and carbonated liquids, with or without stirring. A carbonated liquid should induce more rapid carbonation and dissolution of the active ingredients (cannabinoids, terpenes and cannabidiol [CBD]) due to the inherent CO₂ levels of the carbonated liquid. Accordingly, the excipient components in the supplement powder and the floating delivery system allow for convenient administration in non-carbonated and carbonated liquids. The phrase “supplement powder” as used herein refers to a powder comprising a variety of additives including diluents (e.g., mannitol, sorbitol, xylitol, pearlitol), emulsifiers (e.g., lecithin, locust bean gum, xanthan gum), sweeteners (e.g., sucralose, isomalt, maltitol, aspartame), and lubricants (e.g., sodium benzoate, polyethylene glycol, adipic acid) which facilitate the dispersion of the active ingredients hemp or cannabidiol, cannabis extract to include all cannabinoids and terpenes, including cannabidiol (CBD) into a liquid.

The invention is for the use as a bulk powder supplement, tea mixture, aquaculture, or pet formulation:
Potassium Bicarbonate (100-400 mg)
Citric Acid (100-200 mg)
Pearlitol (10-40 mg)
Isomalt (10-20 mg)
Lecithin (0.100-0.400 mg)
Adipic acid (1-5 mg)
Cannabinoids, terpenes, and cannabidiol [CBD] (1-20 mg)

The active ingredients in the present invention are subjected to a micro jet mill process that yields ingredients of 1.5-2 micron size. A mixture of several ingredients is then oscillated together in a Tubular mixer in order to achieve an evenly distributed blend. Certain ingredients (preservatives) in the bulk powder are slightly larger in particle size, and micro jet mill processing creates a consistent and uniform powder blend of an optimal micron size. In some embodiments, the power blend is less than 200 nm and in other embodiments, the powder blend is less than 100 nm. The micro jet mill process and use of Tubular mixer yield specific micron sizes for each ingredient in the excipient bulk powder. When this method is applied to the proprietary bulk powder blend, a water-soluble excipient powder is achieved. Excipient powders are produced in controlled environmental conditions through various methods that include: direct compression, wet granulation, fluid-bed granulation, and fusion method. As the proposed invention is sensitive to temperature and moisture, modest temperatures (e.g., 25° C.) and a relative humidity of approximately 25% or less must be held constant during production to prevent granulation or adhesion of the excipient powder to the machinery due to moisture absorption.

The excipient powder mix itself contains emulsifiers that aid in the mixing of the bulk powder with the liquid and promotes dispersion when the supplement is added to a liquid. The present inventors recognize that in order to maintain optimal excipient qualities, the matrix of the excipient powder should maintain optimized moisture levels in accordance with the U.S. Pat. No. 6,495,163 with a filing date of Sep. 23, 1998 which is hereby incorporated by reference in its entirety.

For this invention, the excipient activity has been accomplished through the incorporation of sodium or potassium bicarbonate or carbonate (or any other carbonate/bicarbonate consisting of alkali metals) and citric acid (or tartaric acid, malic acid, or any other acid anhydride) in the composition of the excipient powder and/or in the coating. These ingredients react with water to create an acid-base reaction that releases CO₂ and aids in dispersion of the excipient powder. The CO₂ that is produced through an excipient activity reaction increases the penetration of the active substances (hemp or cannabidiol, cannabis extract to include CBD) into the paracellular pathway and subsequently increases ingredient absorption. As used herein, excipient means that the substance in the supplement powder reacts with a liquid and causes the release of gas.

Moreover, the excipient powder may incorporate diluents in the context of the invention. Diluents are described as substances that aid in the breakdown of the bulk powder into a fluid. More specifically, diluents are described as substances intended to aid in the breakup of the compacted mass of the excipient powder when it is put into a fluid environment. Diluents promote moisture penetration and dispersion of the powder. Naturally-sourced diluents include starches, partially pre-gelatinized starches, and hydrolyzed starches. Common diluents for supplement formulation include lactose monohydrate and anhydrous lactose as well as sugar alcohols such as mannitol, sorbitol, pearlitol, and xylitol. Accordingly, as the invention incorporates hemp or cannabidiol, cannabis extract to include CBD, all cannabinoids and terpenes in the supplement powder, the excipient powder incorporates one or multiple diluents that assist the dispersion of the excipient powder once it reaches a liquid. In addition, the invention incorporates one or multiple emulsifiers that promote the dispersion the active ingredient hemp or cannabidiol, cannabis extracts, cannabinoids including CBD and/or terpenes (oil-based substances) in liquid. Common emulsifiers include lecithin, locust bean gum, xanthan gum, sodium mono- and di-glycerols, ammonium phosphatide, and stearoyl lactylate. The invention also incorporates one or multiple sweeteners that are hygroscopic in nature and increase the bulk of the excipient powder. Common sweeteners include sucralose, maltitol, isomalt, and aspartame. Furthermore, the invention incorporates one or multiple water-soluble lubricants (adipic acid, sodium benzoate, and polyethylene glycol) prevent the adhesion of the excipient powder to the device and restrict the formation of insoluble scum on the liquid surface. Additional aspects of the invention are tailored to allow for optimal dissolution time in hot and cold liquids, in different types of liquids, and in the dissolution and delivery of multiple doses.

The dispersion of the excipient powder within the fluid may take approximately 5-20 seconds or longer to fully disperse within the liquid if the supplement powder contains hemp or cannabidiol, cannabis extracts, cannabinoids including CBD and/or terpenes. The excipient powder is designed to dissolve in 3 to 4 ounces of water relatively quickly, for example, after being added or stirred in a container of liquid for a period of time in the range of 1 second to 60 seconds. Excipient generally refers to the release of CO₂, but it can also refer to other gases escaping. In the present invention, the supplement powder is configured to comprise an amount of hemp or cannabidiol, cannabis extracts, cannabinoids including CBD and/or terpenes between 1 milligram and 200 milligrams per dosage. The main advantage of the excipient configuration is that the active ingredients (e.g., CBD) may be absorbed by the body faster when they are consumed in the form of a liquid solution or suspension.

That is, excipient delivery systems are low-density formulations that stay afloat over the gastric fluid and remain buoyant in the stomach without adversely affecting the rate of gastric emptying. This system yields better absorption and increased bioavailability. The buoyancy of the delivery system is assisted by low density agents and compounds such as sodium bicarbonate, citric acid, tartaric acid, or other metal carbonates or alkali metal bicarbonates. These agents present in solid (powder) form and are capable of releasing CO₂ when they are formulated with active ingredients and other auxiliaries to provide granules without the premature evolution of CO₂. The delivery system utilizes excipient reactions when the bulk powder comes in contact with the gastric fluid due to the CO₂ gas that is generated from the system when it is exposed to liquid as water or other liquids act as catalyzing agents that increase the rate of the reaction. The concept of excipient powders is mainly based on the mixture of ingredients such that the active ingredients remain embedded in the delivery system in which the active ingredients are released without the disintegration of the bulk powder. The excipient powder may also be used as a sustain release dosage form to overcome problems that are associated with conventional dosage forms. This also reduces fluctuations of active ingredient(s) concentration and enhances the bioavailability of the bulk powder.

The floating delivery system is designed to yield an excipient powder bulk density that is lower than that of gastric fluid in order for the active ingredients to remain buoyant for extended time periods without affecting the gastric system's emptying rate. The floating delivery systems can be categorized as a non-excipient system or an excipient system. In a non-excipient floating delivery system, the active ingredients swell in the gastric fluid while maintaining relative stability of their shape and a bulk density that is less than the density of the gastric fluid. This augments the floating process of the active ingredient serving forms.

The present invention incorporates an excipient floating delivery system that is based on excipient components (e.g., potassium bicarbonate, citric acid) which will liberate CO₂ due to the acidic properties of the gastric fluid. The liberated CO₂ gas will become entrapped in the floating layer formed by the hydrocolloids (e.g., lecithin, locust bean gum, xanthan gum) and this reaction leads to an upward motion of the active ingredients that also maintains its buoyancy.

The floating delivery system of excipient formulations might offer faster biological effects than non-excipient formulations. A non-excipient solution may also have a bad taste and high viscosity that might increase its intolerability in the digestive tract. Furthermore, an excipient formulation increases the ease of administration and improves the absorption of the active ingredients through the previous dissolution in a buffered liquid medium. In addition, an excipient delivery system can buffer the aqueous solution of the active ingredients, thereby increasing the stomach pH which prevents the inactivation or degradation of the active ingredients. The buffering effect through carbonation may also induce quicker emptying of the stomach, usually within 20-30 minutes into the small intestine as this promotes maximum absorption of active ingredients.

Accordingly, excipient formulations are advantageous as the active ingredients (cannabinoids, terpenes and cannabidiol [CBD]) are already in solution at the time they are consumed, which makes the absorption faster and more complete in comparison to non-excipient formulations. The floating delivery system enables the ingredients to fully dissolve in a buffered solution and this reduces localized contact in upper gastrointestinal tract. This results in less irritation and greater tolerability of the solution. This buffering mechanism also prevents gastric fluids from interacting with active ingredients themselves, which is a major causative factor for esophageal and intestinal upset. Moreover, this system produces a homogenous solution that may have better consumer appeal than viscous, non-excipient solutions. Additionally, this delivery system helps the active ingredients retain their palatability after lengthy storage times. Excellent stability is also inherent to an excipient formulation, particularly surpassing that of non-homogenous liquid solutions.

Active ingredients delivered through excipient delivery systems also have reproducible and predictable bio-kinetic profiles that are more consistent than capsules or tablets, as excipient components assist the therapeutic profiles of the active ingredients. Excipient components also facilitate the solubilization of ingredients that generally demonstrate poorly solubility (cannabinoids, terpenes and cannabidiol [CBD]). An excipient delivery system enhances the penetration of a broad range of active ingredients that vary in size, structure, and other physiological properties. In addition, the excipient formulation can be used for programmed product administration in remote areas and this type of formulation addresses the issue of physicochemical stability and the high cost of transporting capsules, tablets, or viscous syrups. Therefore, an excipient powder provides a realistic solution to easy administration, maximum absorption, sustained active ingredient stability in the gastrointestinal tract, and a low incidence of stomach upset, in addition to other advantages.

Accordingly, the packaged excipient product offers several additional advantages over known products. For example, the packaged product is designed for single use, allowing a consumer to easily transport and consume the hemp or cannabidiol, cannabis derivatives in the form of a excipient powder packet so that when consumers wish to make a drink, all they have to do is introduce the excipient powder to liquid and shake it up with water or another liquid to create the drink. This allows consumers to avoid having to use a scooper with a tub of supplement powder that is bulky and inconvenient to carry around, and also requires measuring, which is another factor that is inconvenient and unhygienic. The package also provides an advantage of being sized to fit in a clothing pocket, purse, or other areas that offer concealment. Advantages also include that large doses of ingredients can be taken in a single serving, and nutrients such as terpenes derived from CBD can be absorbed by the body faster than if they are taken in other forms such as pills.

In particular, the excipient delivery of hemp extract, cannabidiol, cannabis extract, CBD, other cannabinoids terpenes, flavonoids, and other agents (e.g., proteins, extracts), provide highly bioavailable active ingredients of substantial benefit to the peripheral nervous system (for pain management), the immune system, and the gut due to anti-inflammatory and antioxidant properties. Accordingly, an excipient delivery system is an improved method that better delivers the oil-based and easily extracted active ingredient(s). Furthermore, cannabinoids including CBD, terpenes and other hemp and cannabidiol, cannabis extracts do not require heat in order to be extracted and thusly effectively retains additional beneficial compounds (e.g., vitamins, minerals, flavonoids, terpenes, essential fatty acids). With conventional solid tablets or capsules that are swallowed by a consumer, the tablet is transported to the consumer's stomach after being swallowed, where it dissolves gradually. The passage time varies in different people, depending on anatomical and physiological factors. In cases of longer passage times, solid dosage forms can dissolve partially and this may cause irritation of mucous membranes. Advantages of the packaged excipient product include that because it is dissolved in liquid, the ingredients are evenly distributed in the solution and high localized concentrations cannot occur. Furthermore, an excipient powder that is dissolved prior to ingestion maximizes the absorption rate and bioavailability by ensuring that CBD is fully dissolved in liquid before it is delivered to its absorption sites, which are primarily the stomach and the intestine. Dissolution of active ingredients in liquid is a prerequisite to absorption into the systemic (blood and lymphatic) circulation. The series of steps that are required for stomach and intestinal absorption of tablets and capsules are bypassed by administering pre-dissolved (excipient) products. Therefore, the active ingredient(s) is available earlier for absorption, and there is no guarantee that a solid supplement form will release all of the active ingredients contained within it before it transits through intestinal tract to the absorptive sites. Formulations in which the active ingredients are present in dissolved form before it reaches the absorptive sites usually exhibit greater bioavailability. Thusly, the present intervention demonstrates an optimal delivery system in comparison to current delivery systems for hemp and cannabidiol, cannabis such as tablets, capsules, and powders which are not very bioavailable.

While several embodiments have been disclosed, it will be apparent to those of ordinary skill in the art that aspects of the present invention include many more embodiments and implementations. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. An excipient product, comprising:
an excipient supplement powder with a density that enables the excipient powder to dissolve when it is added to or submerged in any liquid, with or without stirring.

2. The excipient product of claim 1, wherein the product is a bulk powder.

3. The excipient product of claim 1, wherein the product is a single use powdered formulation.

4. The excipient product of claim 1, wherein the product is a single use packet.

5. The excipient product of claim 1, wherein the product is a single use sachet.

6. The excipient product of claim 1, wherein the product is a beverage.

7. The excipient product of claim 1, wherein the excipient supplement powder comprising a plurality of additives which facilitate the dispersion of active ingredients hemp or cannabidiol, cannabis extract into a liquid.

8. The excipient powder of claim 7 wherein the plurality of additives, include diluents, emulsifiers, sweeteners, or lubricants.

9. The excipient powder of claim 7 further comprising all cannabinoids, terpenes and cannabidiol (CBD) dispersed into a liquid.

10. A process for producing a water-soluble excipient powder comprising the steps of:
combining a plurality of ingredients wherein at least one ingredient is hemp or cannabidiol, cannabis into a mixture;
introducing the mixture into a micro jet mill;
milling the mixture to form a powder blend;
introducing the powder blend into a mixer; and
mixing the powder blend to form a water-soluble excipient powder.

11. The process of claim 10 wherein the plurality of ingredients further comprising at least one of cannabinoids, terpenes or cannabidiol (CBD).

12. The process of claim 10 further comprising the step of:
adding a diluent.

13. The process of claim 10 further comprising the step of:
adding an emulsifier.

14. The process of claim 10 further comprising the step of:
adding a sweetener.

15. The process of claim 10 further comprising the step of:
adding a lubricant.

16. The process of claim 10 wherein the powder blend is less than 200 nm.

17. The process of claim 10 wherein water-soluble excipient powder contains between about 1-200 milligrams of hemp, cannabidiol, cannabis, or cannabinoids per dosage.

18. A carbonated beverage, comprising:
an excipient supplement powder with a density that enables the excipient powder to dissolve when it is added to or submerged in any liquid, with or without stirring.

19. The carbonated beverage of claim 17, wherein the supplement powder includes hemp.

20. The carbonated beverage of claim 17, wherein the supplement powder includes cannabidiol and cannabis.

21. The carbonated beverage of claim 17, wherein the supplement powder includes cannabinoids.
